(19) United States
(12) Patent Application Publication
(10) Pub. No.: US 2019/0205376 A1
(43) Pub. Date: Jul. 4, 2019

(54) TITLE STANDARDIZATION THROUGH ITERATIVE PROCESSING

(71) Applicant: Microsoft Technology Licensing, LLC, Redmond, WA (US)

(72) Inventors: Uri Merhav, Rehovot (IL); Dan Shacham, Sunnyvale, CA (US); Peide Zhong, Milpitas, CA (US)

(21) Appl. No.: 15/885,004

(22) Filed: Jan. 31, 2018

Related U.S. Application Data
(60) Provisional application No. 62/611,063, filed on Dec. 28, 2017.

(51) Int. Cl. G06F 17/27

(52) U.S. Cl. CPC G06F 17/277; G06F 17/273; G06F 17/2715; G06F 17/2795

(57) ABSTRACT

Example methods and systems are directed to determining a standardized job title corresponding to an input job title. The input job title may be normalized according to various normalization rules to produce a normalized input job title. The normalized input job title may then be tokenized into one or more n-grams, and synonyms may be identified from the various n-grams. A title taxonomy may then be searched using the normalized input job title, the tokenized n-grams, and the identified synonyms, where the search results correspond to standardized job titles that match the various inputs. Each of the candidate job titles may then be scored using congruence type features and information quality features. The highest scoring candidate job title is then selected as the standardized job title for the input job title. An association is then established between the standardized job title and the input job title.

### CROSS-REFERENCE TO RELATED APPLICATIONS

This application claims the benefit of priority to U.S. Pat. App. No. 62/611,063, titled “TITLE STANDARDIZATION THROUGH ITERATIVE PROCESSING” and filed Dec. 28, 2017, the disclosure of which is hereby incorporated by reference in its entirety.

### TECHNICAL FIELD

The subject matter disclosed herein relates to word processing and string tokenizing and, in particular, to determining a standardized word and/or phrase given a raw word and/or phrase as input by iteratively processing and deconstructing the input raw word and/or phrase.

### BACKGROUND

A social networking service may be viewed as a platform to connect people in virtual space. The social networking service may be a web-based platform, such as, e.g., a social networking web site, and may be accessed by a use via a web browser or via a mobile application provided on a mobile phone, a tablet, etc. The social networking service may be a business-focused social network that is designed specifically for the business community, where registered members establish and document networks of people they know and trust professionally.

Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

The social networking service may allow its members to populate his or her member profile with information about his or her employment. This allows the member to inform other members about his or her experience and qualifications. In describing his or her employment, the social networking service may allow the member to freely provide or enter a job title that corresponds to his or her employment. This allows the member to provide the social networking service with what he or she believes is the title of his or her job position.

However, while the ability to freely enter in a job title enhances the member's experience in interacting with the social networking service, such freedom can impact other features provided by the social networking service, such as searching for members having an input job title. As different members may enter different job titles for similar positions, it can be increasingly difficult to identify members with a given job title. This is because the freeform-entered job titles leads to database fragmentation, and the time to search for an input job title among the job titles entered by members increases with each job title entered.

### BRIEF DESCRIPTION OF THE DRAWINGS

Some embodiments are illustrated by way of example and not limitation in the figures of the accompanying drawings.

FIG. 1 is a block diagram illustrating a networked system, according to some example embodiments, including a social networking server.

FIG. 2 illustrates the social networking server of FIG. 1, according to an example embodiment.

FIG. 3 illustrates a workflow diagram for determining a standardized job title for an input jab title, according to an example embodiment.

FIGS. 4A-4C are flow diagrams illustrating, in accordance with an example embodiment, a method for determining a standardized job title for an input job title.

FIG. 5 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods and systems are directed to standardizing job titles entered in by members of a social networking service, and matching those job titles with canonical job titles previously entered into the social networking service. The standardizing of the member-entered job titles leads to increased database coherency, which reduces the time it takes for a search function to identify members of the social networking service having a job title that is similar to, or matches, an input job title. In one embodiment, standardizing a job title includes suggesting a determined job title to a member given an input job title provided by the member. In another embodiment, standardizing a job title includes creating an association between the input job title provided by the member and the determined job title.

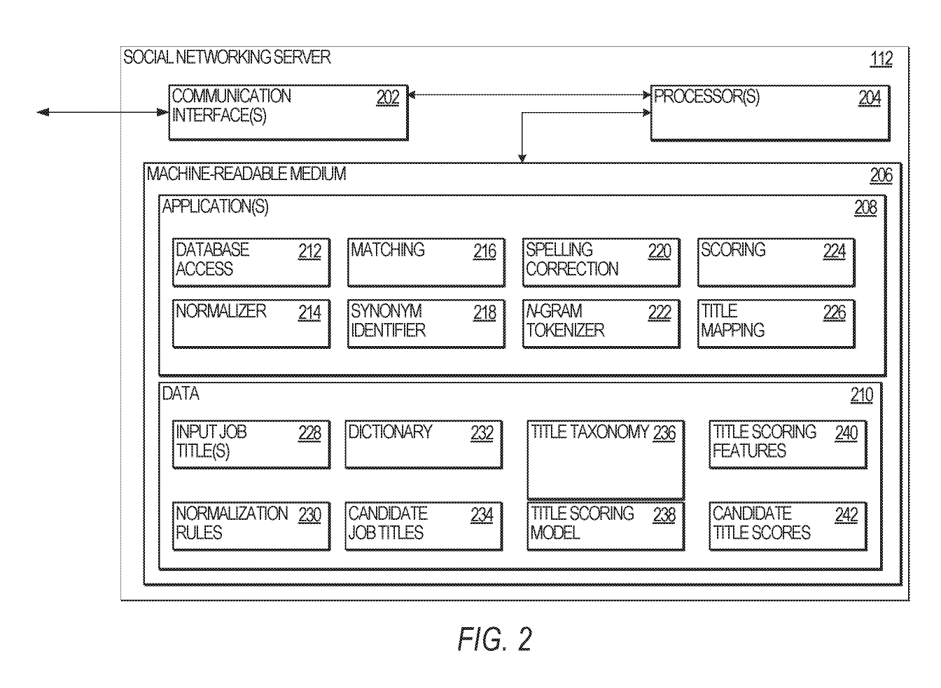

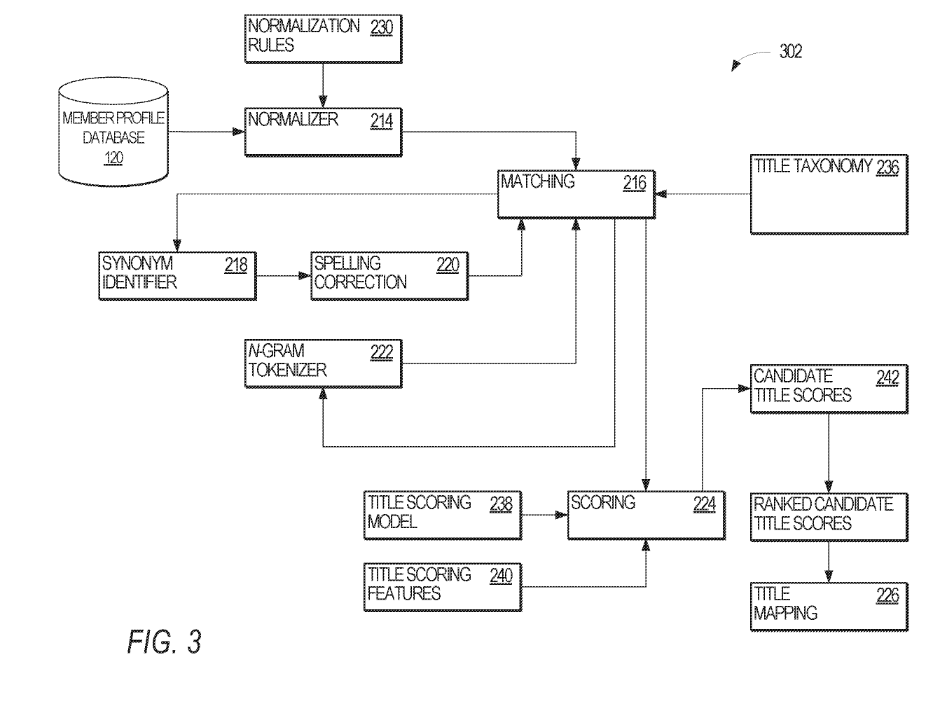

To determine whether an input job title corresponds to a standardized job title, the social networking server may iteratively process the input job title using various modules and processes. These processes include, but are not limited to, normalizing the input job title, tokenizing the input job title into one or more n-grams, performing a synonym identification and/or spell correction, and stemming the one or more n-grams. After each of the processes, the social networking server may input the tokenized input job title phrases, the stemmed tokens of the input job title, and other such deconstructions of the input job title into a trained (e.g., supervised or unsupervised) machine learning classifier that determines and ranks potential candidates, from among the standardized job titles, for the provided input words and/or phrases. As discussed below with regard to reference FIGS. 2-3, the machine learning classifier may use one or more classifier features in determining the potential candidates. Having determined the ranked candidates most likely to correspond to the input job title, the social networking server then selects the highest ranked candidate as the standardized job title that matches, or most closely matches, the input job title. In some instances, there may be multiple candidates that are ranked highest, or within a degree of tolerance, and the social networking server may request the member that provided the input job title to select the candidate from among the multiple, matching candidates.

In one embodiment, the social networking server then creates the association between the input job title and the determined, standardized job title. In this regard, creating an association may include populating a database field of a member profile with the determined job title, populating a database field of the member profile with an identifier corresponding to the determined job title, replacing an input job title with the standardized job title, or other such manner of creating an association between the input job title and the standardized job title.

At least one technical benefit provided by this disclosure is one of database data standardization and coherency. As known to one of ordinary skill in the art, one of the challenges in comparing data provided users so that, often times, the input data does not conform to any one standard. Thus, comparing the input data can be challenging and resource intensive as the server or computer performing the comparison may not understand, or be programmed with, the differences in the input data. Thus, this disclosure provides a mechanism by which input data, in the form of member job titles, is standardized, resulting in faster database searches, meaningful comparisons (e.g., between a first member job title provided by one member with a second member job title provided by a second member), and useful analyses.

In one embodiment, the member profiles for the social networking service are stored in a member profile datastore, such as database. As members of the social networking service populate their respective member profiles with freely entered job titles, the number of potentially different job titles increases as well. As each member profile may have a different job title associated with it, the order of complexity on which to search for member profiles having a given job title is, at least, O(n), where n is the number of member profiles. The search complexity is about O(n) because the member profile database can become fragmented across input job titles. However, by determining a standardized job title for each input job title, the coherency of the member profile database is preserved as each member profile is expected to be associated with a known (e.g., standardized) job title. Thus, the order of complexity for searching the member profile database for member profiles associated with a given job title does not increase significantly with each added member. In one embodiment, as the number of member profiles scales upwards to hundreds of thousands of member profiles, the order on which to search those member profiles for a given job title scales to about O (log n). In this manner, the technical benefits provided by this disclosure include the preservation of database integrity, reduced search times, a reduction in computing resources (e.g., expended and/or used in conducting a search), and other similar technical benefits related to conducting a database search.

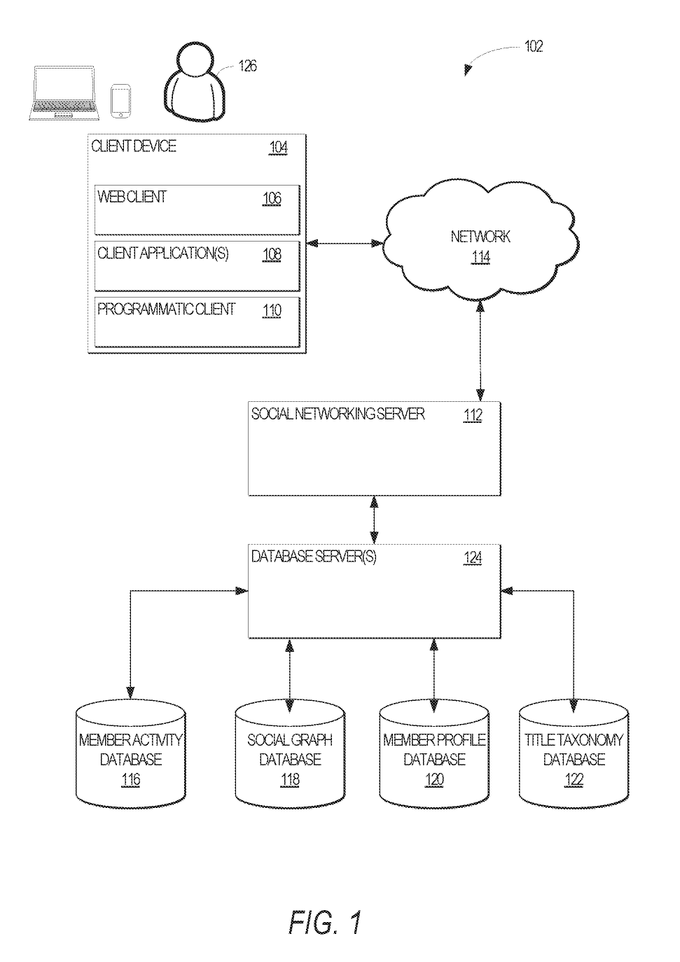

With reference to FIG. 1, an example embodiment of a high-level client-server-based network architecture 102 is shown. A social networking server 112 provides server-side functionality via a network 114 (e.g., the Internet or wide area network (WAN)) to one or more client devices 104. FIG. 1 illustrates, for example, a web client 106 (e.g., a browser, such as the Internet Explorer® browser developed by Microsoft® Corporation of Redmond, Wash. State), client application(s) 108, and a programmatic client 110 executing on client device 104. The social networking server 112 is further communicatively coupled with one or more database servers 124 that provide access to one or more databases 116-122.

The client device 104 may comprise, but is not limited to, a mobile phone, desktop computer, laptop, portable digital assistant (PDA), smart phone, tablet, ultra book, netbook, laptop, multi-processor system, microprocessor-based or programmable consumer electronic, or any other communication device that a user 126 may utilize to access the social networking server 11.2. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth. The client device 104 may be a device of a user 126 that is used to perform one or more searches for user profiles accessible to, or maintained by, the social networking server 112.

In one embodiment, the social networking server 112 is a network-based appliance that responds to requests from the client device 104 to provide one or more services. A user 126 may use the client device 104, and the one or more users 128 may be a person, a machine, or other means of interacting with the client device 104. In various embodiments, the user 126 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, a web browser, messaging application, electronic mail (email) application, a social networking access client, and the like. In some embodiments, if the social networking access client is included in the client device 104, then this application is configured to locally provide the user interface and at least some of the functionalities with the application configured to communicate with the social networking server 112, on an as needed basis, for data and/or processing capabilities not locally available (e.g., access to a member profile, to authenticate a user 126, to identify or locate other connected members, etc.). Conversely if the social networking access client is not included in the client device 104, the client device 104 may use its web browser to access the initialization and/or search functionalities of the social networking server 112.

One or more users 128 may be a person, a machine, or other means of interacting with the client device 104. In example embodiments, the user 126 is not part of the network architecture 102, but may interact with the network architecture 102 via the client device 104 or other means. For instance, the user 126 provides input (e.g., touch screen input or alphanumeric input) to the client device 104 and the input is communicated to the client-server-based network architecture 102 via the network 114. In this instance, the social networking server 112, in response to receiving the input from the user 126, communicates information to the client device 104 via the network 114 to be presented to the user 126. In this way, the user 126 can interact with the social networking server 112 using the client device 104.

Further, while the client-server-based network architecture 102 shown in FIG. 1 employs a client-server architecture, the present subject matter is of course not limited to such an architecture, and could equally well find application in a distributed, or peer-to-peer, architecture system, for example.

In addition to the client device 104, the social networking server 112 communicates with other one or more database server(s) 124 and/or database(s) 116-122. In one embodiment, the social networking server 112 is communicatively coupled to a member activity database 116, a social graph database 118, a member profile database 120, and a job posting database 122. The databases 116-122 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some embodiments, when a person initially registers to become a member of the social networking service provided by the social networking server 112, the person is prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the member profile database 120. Similarly, when a representative of an organization initially registers the organization with the social networking service provided by the social networking server 112, the representative may be prompted to provide certain information about the organization. This information may be stored, for example, in the member profile database 120. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

A member profile may also include information identifying one or more skills that a corresponding has identified as possessing. For example, the member may identify that he or she possesses computer programming skills (e.g., “Computer Programming,” “Debugging,” “C++,” etc.), writing skills (e.g., “Writing,” “Drafting,” etc.), legal skills (e.g., “Contract drafting,” “Document review,” “Litigation,” etc.) and other such skills and/or combination of skills. In one embodiment, the member provides information to the social network service via a graphical user interface (e.g., a webpage), which then updates the member's member profile with the provided skills. Additionally, and/or alternatively, the social networking service may provide a list and/or selectable skills that the member may identify as possessing. In this manner, a member profile includes skills that the member has identified as possessing.

The member profile data may further include a description or summary of the type of tasks and/or jobs that the member has performed during his or her career and/or associate them with one or more organizations. In one embodiment, the social networking server 112 provides a graphical user interface, such as a webpage, for the member to provide member profile data for the corresponding member profile. In one example, the member may provide one or more job titles corresponding to positions at organizations at which the member was previously employed or is currently employed. In one embodiment the member may provide the one or more job titles using an input element of the webpage, such as a text field. As another example, the member may provide a description of the type of work that he or she has performed while employed at a given employer. Similarly, the member may provide a description of the type of courses and/or activities that he or she engaged in while attending a given educational institution (e.g., a university). Regardless of the organization type (e.g., educational, government, private company, non-profit, etc.), the social networking service provides the graphical user interface (e.g., a webpage) that allows the member to provide information about his or her duties and/or activities while attending or employed at a given organization. Thus, the member profile may be leveraged as a substitute résumé for the corresponding member.

With regard to the input job title, the social networking server 112 may leverage various modules, applications, and/or processes to determine a standardized job title from the input job title. In one embodiment, the social networking server 112 determines the standardized job title from the input job title after the member has typed out the input job title and has submitted the input job title to the social networking server 112 to record in the member profile (e.g., via a POST request or PUT request). In another embodiment, the social networking server 112 determines the standardized job title after the member has supplied (e.g., typed) a threshold number of characters for the input job title (e.g., six or more characters). The social networking server 112 may then display, via the webpage displayed on the client device 104, a predetermined number of candidate job titles that the social networking server 112 has determined “best” correspond to the input job title. In this context, “best” refers to a ranked position; thus, the social networking server 112 may return or display the three, four, five, etc., highest ranked standardized job titles that correspond to the input job title. The member may then select from among the displayed the standardized job titles the standardized job title that the member believes best corresponds to the input job title.

The member profile data may also include geographic information about the member. The geographic information may include, but is not limited to, the current and/or approximate location of the member, the approximate location of the member where he or she last accessed the social networking server 112, the approximate location of one or more employers of the member, such as a current employer or past employer(s), and other such geographic information or combination of information. The geographic information may be generic as to a region Northeast), may identify a particular city, state, province, country, or may be particular as to a specific latitude and/or longitude. In this manner, the member profile includes geographic information about the corresponding member.

Members of the social networking service may establish connections with one or more members and/or organizations of the social networking service. The connections may be defined as a social graph, where the member and/or organization is represented by a vertex in the social graph and the edges identify connections between vertices. In this regard, the edges may be bilateral (e.g., two members and/or organizations have agreed to form a connection), unilateral (e.g., one member has agreed to form a connection with another member), or combinations thereof. In this manner, members are said to be first-degree connections where a single edge connects the vertices representing the members; otherwise, members are said to be “nth”-degree connections where “n” is defined as the number of edges separating two vertices. As an example, two members are said to be “2nd-degree” connections where each member shares a connection in common with the other member, but the members are not directly connected to one another. In one embodiment, the social graph maintained by the social networking server 112 is stored in the social graph database 118.

Although the foregoing discussion refers to “social graph” in the singular, one of ordinary skill in the art will recognize that the social graph database 118 may be configured to store multiple social graphs. For example, and without limitation, the social networking server 112 may maintain multiple social graphs, where each social graph corresponds to various geographic regions, industries, members, or combinations thereof.

As members interact with the social networking service provided by the social networking server 112, the social networking server 112 is configured to monitor these interactions. Examples of interactions include, but are not limited to, commenting on content posted by other members, viewing member profiles, editing or viewing a member's own profile, sharing content outside of the social networking service (e.g., an article provided by an entity other than the social networking server 112), updating a current status, posting content for other members to view and/or comment on, and other such interactions, in one embodiment, these interactions are stored in a member activity database 116, which associates interactions made by a member with his or her member profile stored in the member profile database 120.

The social networking server 112 may further communicate with a title taxonomy database 122 that stores the standardized job titles the social networking server 112 uses to determine for an input job title. In one embodiment, the standardized job titles of the title taxonomy database 122 are structured as an acyclic tree, where internal nodes of the tree represent “supertitles” and leaf nodes of the tree represent particular job titles. In one embodiment, each leaf node of the acyclic tree represents a unique standardized job title such that no two leaf node represent the same standardized job title. In addition, the acyclic tree may include aliases that associate particular job titles with a particular standardized input job title. These aliases may be entered by an administrator or other authorized user designated to edit and/or modify the title taxonomy database 122. The aliases allow a matching between an input job title and a standardized job title even if the input job title does not exactly match the standardized job title (e.g., an alias that matches the input job title “senior software developer” with the standardized job title “senior software engineer”).

The root node of the acyclic tree may be a placeholder that identifies various supertitles that the social networking server 112 should first search to determine potential standardized job titles from the input job title. In this context, the term “supertitle” refers to a job title that has possible variations, synonyms, alternative spellings, and other such constructs. Furthermore, a supertitle node of the tree taxonomy may have one or more child nodes that are also supertitles. In this manner, the social networking server 112 leverages the title taxonomy database 122 to determine potential standardized job titles given an input job title by a member of the social networking service.

In one embodiment, the social networking server 112 communicates with the various databases 116-122 through one or more database server(s) 124. In this regard, the database server(s) 124 provide one or more interfaces and/or services for providing content to, modifying content in, removing content from, or otherwise interacting with, the databases 116-122. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates with the databases 116-122 and includes a database client, engine, and/or module, for providing data to, modifying data stored within, and/or retrieving data from, the one or more databases 116-122.

While the database server(s) 124 is illustrated as a single block, one of ordinary skill in the art will recognize that the database server(s) 124 may include one or more such servers. For example, the database server(s) 124 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-122, or combinations thereof Accordingly, and in one embodiment, the database server(s) 124 implemented by the social networking service are further configured to communicate with the social networking server 112.

FIG. 2 illustrates the social networking server 112 of FIG. 1, in accordance with an example embodiment. In one embodiment, the social networking server 112 includes one or more processor(s) 204, one or more communication interface(s) 202, and a machine-readable medium 206 that stores computer-executable instructions for one or more applications 208 and data 210 used to support one or more functionalities of the applications 208.

The various functional components of the social networking server 112 may reside on a single device or may be distributed across several computers in various arrangements. The various components of the social networking server 112 may, furthermore, access one or more databases (e.g., databases 116-122 or any of data 210), and each of the various components of the social networking server 112 may be in communication with one another. Further, while the components of FIG. 2 are discussed in the singular sense, it will be appreciated that in other embodiments multiple instances of the components may be employed.

The one or more processors 204 may be any type of commercially available processor, such as processors available from the Intel Corporation, Advanced Micro Devices, Texas Instruments, or other such processors. Further still, the one or more processors 204 may include one or more special-purpose processors, such as a Field-Programmable Gate Array (FPGA) or an Application Specific integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The one or more communication interfaces 202 are configured to facilitate communications between the client device 104, the social networking server 112, and one or more of the database server(s) 124 and/or databases 116-122. The one or more communication interfaces 202 may include one or more wired interfaces (e.g., an Ethernet interface, Universal Serial Bus (USB) interface, a Thunderbolt® interface, etc.), one or more wireless interfaces (e.g., an IEEE 502.11b/g/n interface, a Bluetooth® interface, an IEEE 502.16 interface, etc.), or combinations of such wired and wireless interfaces.

The machine-readable medium 206 includes various applications 208 and data 210 for implementing the client device 104. The machine-readable medium 206 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof The term “machine-readable medium” should be taken to include a single medium or multiple media (e.g., a centralized or distributed database, or associated caches and servers) able to store the applications 208 and the data 210. Accordingly, the machine-readable medium 206 may be implemented as a single storage apparatus or device, or, alternatively and/or additionally, as “cloud-based” storage systems or storage networks that include multiple storage apparatus or devices. As shown in FIG. 2, the machine-readable medium 206 excludes signals per se.

In one embodiment, the applications 208 are written in a computer-programming and/or scripting language. Examples of such languages include, but are not limited to, C, C++, C#, Java, JavaScript, Perl, Python, or any other computer programming and/or scripting language now known or later developed.

With reference to FIG. 2, the applications 208 of the social networking server 112 are configured to determine one or more standardized job titles from an input job title provided by the client device 104 in communication with the social networking server 112. To perform these and other operations in determining the one or more standardized job titles, the modules 208 include, but are not limited to, a database access application 212, a normalizer 214, and a matching application 216. The applications 208 may further include a synonym identifier 218, a spelling correction application 220, an n-gram tokenizer 222, and a scoring application 224. Finally, the applications may include a title mapping application 226 that establishes or creates an association between an input job title and one or more standardized job titles. While the social networking server 112 may include alternative and/or additional modules or applications (e.g., a networking application, a printing application, an operating system, a web server, various background and/or programmatic services, etc.), such alternative and/or additional applications are not germane to this disclosure and the discussion of such is hereby omitted for brevity and readability.

The data 210 referenced and used by the applications 208 include various types of data in support of determining the one or more standardized job titles for the input job title. In this regard, the data 210 includes, but is not limited to, one or more input job title(s) 228 (e.g., a job title input by a member that interacts with the social networking server 112 and/or or a job title obtained from a member profile selected from the member profile database 120), one or more normalization rules 230, an electronic dictionary 232, one or more candidate job titles determined using the application(s) 208, the title taxonomy 236 stored in the title taxonomy database 122, a title scoring model 238 used to score the various candidate titles 234, one or more title scoring features 240 used in the title scoring model 238, and the candidate title scores 242 determined for each of the candidate titles 234.

In determining a standardized job title that corresponds to the input job title, the social networking server 112 may implement two general processes: 1) a first process to determine whether there is an exact (e.g., identical) standardized job title matching the input job title; and, if the first process is unsuccessful, 2) determine a candidate set of standardized job titles that are likely to match with the input job title. As the social networking server 112 manipulates and modifies the input job title, the social networking server 112 attempts to match the input job title with a standardized job title after each modification and/or edit.

The database access application 212 is configured to access, modify, retrieve, and/or store data in one or more of the databases 116-122. In one embodiment, the database access application 212 is implemented using the Java Database Connectivity (JDBC) application programming interface. The database access application 212 may retrieve information from one or more member profile(s) from the member profile database 120, such as one or more job titles that the member corresponding to the member profile has provided to the social networking server. The database access application 212 may also store information and/or create associations within a member profile entry corresponding to the member profile stored in the member profile database 120. The database access application 212 may further store and/or retrieve information from the title taxonomy database 124, such as the title taxonomy 236 and/or the one or more candidate job titles 234. In this manner, the social networking server 112 uses the data base access application 212 to access one or more databases 116-122 and, more particularly, to accessing various entries stored within the database 116-122.

The normalizer 214 is configured to modify (e.g., “normalize”) one or more input job titles according to one or more normalization rules 230. In one embodiment, the normalization rules 230 define the permissible characters of an input job title. The permissible characters may be selected from one or more spoken and/or written languages. In this regard, the normalization rules 230 may specify whether the normalizer 214 is to remove and/or modify one or more characters of the input job title.

In addition, the normalization rules 230 may include one or more rules corresponding to specific written and/or spoken languages. For example, the permissible characters may include those letters found in the English language, the Spanish language, the Chinese language, or any other language or combination of languages. In one embodiment, the normalizer 214 selects those normalization rules 230 that correspond to a language identified in a member profile corresponding to the input job title being processed by the normalizer 214. Thus, if the member profile includes a language field identifying that the member profile is written in the English language, the normalizer 214 selects those normalization rules 230 written for processing input job titles in the English language.

The normalizer 214 may be implemented using one or more computer programming and/or scripting methods. For example, the normalizer 214 and/or the normalization rules 230 may be implemented as regular expressions and the input job title may be defined as a String object in the Java computer programming language. This regard, the normalizer 214 may invoke one or more of the methods defined by the String class in the Java computer programming language to manipulate individual characters of the input job title.

In addition to the language, the normalization rules 230 may define whether the normalizer 214 is to modify one or more characters of the input job title. For example, the normalization rules 230 may define that the input job title is to include only lowercase characters of the English language from “a” to “z” inclusive. Thus, in this example, the normalizer 214 swaps one or more uppercase characters for lowercase characters. Furthermore, still referring to the foregoing example, the normalizer 214 may swap those characters having accents or other special marks with their non-accented forms (e.g., swapping “é” for “e” or “i” for “i”). In this manner, the normalizer 124 is configured to modify the input job title to a format defined by the normalization rules 230.

Having normalized the initial input title to produce a normalized input job title, the social networking server 112 then executes a matching application 216 to identify one or more matches for the normalized input title. The matching application 216 is configured to determine whether a given input title matches to one or more of the standardized job titles in the title taxonomy 236. In this regard matching application 216 may be configured to traverse the title taxonomy 236 and determine whether there is at least one job title in the title taxonomy 236 that matches in the input title. In one embodiment, the matching application 216 is configured to determine an exact match of a job title for the input job title. In this regard, an exact match includes, but is not limited to matching the input job title to any standardized title in the title taxonomy 236, matching a spell-corrected version of the input job title (e.g., by the spelling correction application 220) to any standardized job title in the title taxonomy 236, and/or matching the input job title using any aliases entered into the title taxonomy 236 (e.g., an alias that indicates the input job title of “software developer” matches to the standardized job title “software engineer”).

In this embodiment, an exact match is one where the input job title and the job title from the title taxonomy have the same alphanumeric characters, regardless of capitalization, accent marks, or other superfluous formatting and/or punctuation. In another embodiment, the matching application 216 is configured to determine an approximate match of a job title for the input job title. In this embodiment, the matching application 216 may perform the approximate matching using an approximate string matching algorithm or fuzzy matching algorithm, with a predetermined Levenshtein distance threshold. Further still, the matching application 216 may be configured to perform both exact matching and fuzzy matching. Regardless of the embodiment employed by the matching application 216, the matching application 216 determines a job title from the title taxonomy 236, and returns the determined job title as a candidate job title 234. As discussed below, the social networking server 112 may invoke the matching application 216 more than once in determining candidate job titles for an input job title.

In the event that the social networking server 112 is unable to determine an exact match, the social networking server 112 then generates the set of candidate job titles 234 by tokenizing the input job title(s) 228. In one embodiment, the process of generating the set of candidate job titles 234 includes normalizing the input job title(s) 228 via the normalizer 214 (e.g., to remove punctuation, to remove unnecessary white spaces, invalid characters, etc.), removing one or more unigrams obtained by the n-gram tokenizer 222 (discussed below) that do not appear in the title taxonomy 236, using the synonym identifier 218 (discussed below) on the obtained unigrams and/or bigrams from the n-gram tokenizer 222 to identify synonyms (e.g., replacing or changing the word “admin” to “administrator,” replacing or changing the word and “teach” to “teacher,” replacing or changing the word “goalkeeper” to “athlete”), and/or using the synonym identifier 218 to perform word expansion on words and/or phrases within the input job title. The social networking server 112 may then generate one or more n-grains (e.g., unigrams, bigrams, trigrams, etc.) from the words and/or phrases output by the synonym identifier 218.

The synonym identifier 218 is configured to determine one or more synonyms for an input word and/or phrase. In one embodiment, the synonym identifier 218 is implemented using the Java OpenThesaurus Library (JOTL), which is available from Github.com. The JOTL provides an API to access the OpenThesaurus project, which provides access to synonyms of a large dictionary of words. In this embodiment, the dictionary 232 may be provided by the OpenThesaurus project and accessible via a Uniform Resource Location (URL) using the JOTL. In another embodiment, the synonym identifier 218 is implemented as the Java API for WordNet Searching (JAWS), and the dictionary 232 is a copy of the dictionary provided by the WordNet project, located at wordnet.princeton.edu.

In one embodiment, the input word and/or phrase are unigrams of the input job title selected from the input profile job title(s) 228. For each unigram, the synonym identifier 218 returns one or more synonyms and maintains a list of these one or synonyms for each input unigram. In addition, the synonym identifier 218 may be configured to perform word expansion on the input word and/or phrase. In this regard, the dictionary 232 may include abbreviated words associated with their expanded counter-parts (e.g., “sr.” expands to “senior,” “jr.” expands to “junior,” “eng.” expands to “engineer,” etc.). In this manner, where the input word and/or phrase is a shortened word or acronym for the synonym identifier 218, the synonym identifier 218 outputs a corresponding expanded word and/or phrase.

The synonym identifier 218 may then swap unigrams in the input job title with their respective synonyms, and then input the swapped input job titles to the matching application 216 to perform the matching process on the swapped input job title. The synonyms for each of the unigrams may be stored in an n-dimensional array logical construct, where n represents the number of unigrams in a given input job title. For example, where an input job title consists of two unigrams, the synonym identifier 218 constructs a two-dimensional array, where the first index of the array corresponds to the first unigram of the input job title, and the second index of the double array corresponds to a synonym associated with the first unigram identified by the first index.

Accordingly, the matching application 216 may determine candidate job titles for the swapped input job titles by traversing the indices of the n-dimensional array, and constructing swapped input job titles by combining each word identified by an index selected from the an n-dimensional array with every other word identified by the other indices selected from the n-dimensional array. As example, where an input job title consists of two unigrams, and each unigram is associated with two synonyms, there are nine possible swapped input job titles. In this example, the nine swapped input job titles are used as input by the matching application 216 to generate a candidate list of standardized job titles for the original, input job title.

The spelling correction application 220 is configured to determine whether an input word is misspelled and, if so, replace the misspelled word with its correctly spelled counter-part. In one embodiment, the spelling correction application 220 is implemented using the Bing® Spell Check API, which provides access to a Microsoft® spellchecking service. In one embodiment, the spelling correction application 220 is instantiated and/or executed by other applications 208 of the social networking server 112, such as the synonym identifier application 218, the matching application 216, or other such applications 208.

The result of the spelling correction application 220 may be used to replace one or more words of an input job title. For example, where the input job title is entered as “Sosial Directer,” the synonym identifier application 218 and/or the matching application 216 may provide the unigrams of “Social” and “Directer” as input to the spelling correction application 220. In turn, the spelling correction application 220 may output “Social” and “Director,” which then replace their corresponding misspelled counter-parts in the input job title.

In some instances, the spelling correction application 220 may be unable to identify and/or determine a correctly spelled version of an input word and/or phrase. In these instances, the spelling correction application 220 may output a message or prompt, or may set a flag or variable, that indicates that an error has occurred. By generating such an error message or by setting a corresponding flag or variable, the spelling correction application 220 provides a notification to a member or the social networking server 112 that further inspection of the input word and/or phrase is suggested.

The n-gram tokenizer 222 is configured to tokenize an input job title into one or more words and/or phrases. In one embodiment, the n-gram tokenizer 222 generates unigrams from an input job title. In another embodiment, the n-gram tokenizer 222 generates bigrams from the input job title. Furthermore, the n-gram tokenizer 222 may be configured to output multiple different types of n-grams, such as unigrams and bigrams. Each of the unigrams and/or bi-grams may be used as input for one or more of the applications 208 of the social networking server 112, such as the matching application 216, the synonym identifier application 218, the spelling correction application 220, or other such applications 208 or combinations of applications. The n-gram tokenizer 222 may be implemented using the Java Lucene library, which is available from the Apache Software Foundation.

The result of processing the input job title(s) 228 through the normalizer 214, and/or the synonym identifier 218, and/or the spelling correction application 220, and/or the n-gram tokenizer 222 is that the social networking server 112 obtains an intermediate set of job titles or, as used in this disclosure, a set of “normalized” job titles. In addition, and to avoid redundant efforts, the social networking server 112 may filter out those normalized job titles that are unigrams and are included in at least one other normalized job title. For example, the word “engineer” may be removed from the candidate job titles 234 where the candidate job titles also includes “software engineer” and/or “civil engineer.” Accordingly, in one embodiment, the candidate job titles 234 excludes those job titles that are unigrams which constitute a portion or part of another candidate job title. In an alternative embodiment, the unigram candidate job titles are not filtered out, and the candidate job titles 234 includes all of the normalized job titles.

Using the normalized job titles as input, the matching application 216 attempts to match each of the normalized job title with a standardized job title in the title taxonomy 236. Where a match is determined (e.g., an exact match between the normalized job title and the standardized job title), the matching application 216 adds the determined standardized job title to the set of candidate job titles 234 for the input job title from which the normalized job titles were derived.

The scoring application 224 is configured to score and/or rank each of the candidate job titles 234. In one embodiment, the scoring application 224 uses a title scoring model 238 and title scoring features 240 to score the various candidate job titles 234. The scoring application 224 may be implemented as a supervised machine-learning classifier or an unsupervised machine-learning classifier. The score assigned to a given candidate job title may be referred herein as a “candidate title score.” Thus, the scoring application 224 obtains candidate title scores 242 for each of the candidate job titles 234.

In one embodiment, the score assigned to a given candidate job title is a zero to one value, inclusive, that provides a measure of confidence in the validity of the mapped job title. In this regard, the score assigned to a given candidate job title corresponds to a measure of probability that the candidate job title would be judged by a human to be a “correct” standardized title for the corresponding input job title.

A candidate title score may be represented by two general concepts: 1) congruence between the input job title and the determined, matching standardized job title (e.g., the input job title “eng” and the matching standardized job title “engineer” have a high congruence) and, 2) information quality of the standardized job title (e.g., the standardized job title of “freelance” has very low information quality because the term “freelance” does not convey what type of freelance activity the member engages in).

In computing the candidate title score, the scoring application 224 maintains two values in the process: 1) the words from the normalized job title that were successfully mapped into a standardized job title—these words are referenced as “matched words”; and 2) the words from the normalized job title that were left unmapped into a standardized job title these words are referenced as “unmatched words.” By tracking matched and unmatched words, the scoring application 224 can compare the normalized compare the input job title (via the normalized job title) with the standardized job title and differentiate between those instance where important information was lost and those instances where redundant information was lost. As an example, the mapping of “machine learning engineer” to “engineer” loses very important piece of the title (e.g., the phrase “machine learning”) whereas the mapping of “freelance data scientist” to “data scientist” loses some, less important information (e.g., the word “freelance”). The use of the matched and unmatched word values reflects this differentiation in the candidate title score assigned to each standardized job title.

In computing the candidate title score for a corresponding input job title, the scoring application 224 leverages one or more title scoring features 240 for a title scoring model 238. To determine the title scoring features 240, the social networking server 112 initially defines two metrics for every word (or n-gram) selected from the corpus of input job titles that members of the social networking service have entered: document frequency (DF) and complete phrase probability. In one embodiment, DF is determined as log(n), where n is a number of times that a given word or n-gram appears within the corpus of input job titles. In some instances, the document frequency may be nonlinear. The social networking server 112 may be further configured with an upper count threshold that indicates that the word or n-gram is likely a “stop” word. Examples of stop words include “of” “the,” “in,” and other such words. The social networking server 112 may also be configured with a lower count threshold that indicates that the word or n-gram is rare, specific, or unimportant. Words or n-grams that have a log(n) value that is lower than the lower count threshold or higher than the upper count threshold may be ignored or discounted.

The metric of complete phrase probability indicates whether a given word or n-gram represents the complete title for a given profession. This value may be determined for each word and/or n-gram used in the title taxonomy 236 and/or determined from each word and/or n-gram used in the corpus of job titles retrieved from member profiles stored in the member profile database 120. In one embodiment, this value is a ratio that represents the number of times a given word and/or n-gram appears in the corpus of job titles for the member profiles stored in the member profile database 120 versus the number of times the word and/or n-gram was found in the complete title for the job titles of the member profiles. One example of such a word is “teacher,” which is likely to represent the complete job title. A counter-example is the word “data,” which is unlikely to be used by itself to represent a job title. The social networking server 112 may store a logically arranged datastore, such as a two-dimensional table, that associates (e.g., “maps”) n-grams with their corresponding complete phrase probability. This disclosure refers to these associations as the “complete phrase probability map.” In one embodiment, the complete phrase probability map is determined prior to the social networking server 112 attempting to match input job titles with standardized job titles selected from the title taxonomy 236.

The document frequency value and the complete phrase probability value are then further used by the social networking server 112 to determine the title scoring features 240 for the title scoring model 238. In one embodiment, the title scoring model 238 is implemented as a regularized logistic regression model and the title scoring features 240 are features for the regularized logistic regression model. The title scoring model 238 and the scoring application 224 may be implemented using the scikit-learn library for the Python computer-programming language. As known to one of ordinary skill in the art, scikit-learn is a machine learning library that features various classification, regression and clustering algorithms including support vector machines, random forests, gradient boosting, k-means and density-based spatial clustering of applications with noise (DBSCAN), and is designed to inte operate with the Python numerical and scientific libraries NumPy and SciPy. Scikit-learn is available from scikit-learn.org. Accordingly, while the title scoring model 238 may be implemented as a logistic regression model, the title scoring model 238 may also be implemented as a random forest classifier and/or gradient boosting tree via the scikit-learn library.

The title scoring features 240 may be categorized into two types of features: congruence features and information quality features. A congruence feature generally indicates whether there is a match between a token selected from a first input (e.g., a synonym job title, the normalized input job title, etc.) and a token selected from a second input (e.g., the candidate job title). An information quality feature generally indicates how much information is conveyed or lost between the first input and the second input. Table 1, below, lists the congruence type features, including a brief description for each. Table 2, also below, lists the information quality features, including a brief description for each. In determining the values for each of the congruence type and information quality type features, the normalized job title corresponding to the input job title and a candidate job title selected from the candidate job titles 234 are each tokenized into one or more n-grains, and the resulting n-grains of the normalized job title are compared with the resulting n-grams of the candidate job title.

TABLE 1

| Congruence Type Feature | |
|---|---|
| Name | Description |
| HITS_NUM | Represents the number of matched tokens |
| | from the tokenized n-grams. A higher value |
| | indicates more matches. |
| FIRST_HIT_LOCATION | Represents the location of the first matching |
| | token. A lower value is better. |
| MAX_SKIP | The maximum number of bi-gram skips |
| | introduced in the mapping between the |
| | normalized input job title and the candidate |
| | job title. One example is where “software |
| | networking development engineer” maps to |
| | “software engineer.” In this example, the |
| | MAX_SKIP is two. |
| MAX_NEGATIVE_SKIP | The maximum number of unigrams that were |
| | reversed in mapping the normalized input |
| | job title to the candidate job title. |
| | MAX_NEGATIVE_SKIP is typically a |
| | negative value. One example is where |
| | “engineer software” is mapped to “software |
| | engineer.” In this example, the |
| | MAX_NEGATIVE_SKIP is −1. |
| | MAX_NEGATIVE_SKIP may be assigned a |
| | zero value where the unigram ordering is |
| | unchanged in mapping the normalized input |
| | job title to the candidate job title. |

TABLE 2

| Information Quality Type Feature Name | Description |
|---|---|
| LOST_WORD_LOG_COUNT | Represents the minimum value of all |
| | unmatched tokens. In one embodiment, this |
| | value is determined as min(log(DF)) of the |
| | unmatched tokens. |
| MATCHED_WORD_LOG_COUNT | Represents the minimum value of all |
| | matched tokens. In one embodiment, this |
| | value is determined as min(log(DF)) of the |
| | matched tokens. |
| MATCH_WORD_COMPLETENESS | Represents the maximum value of the |
| | complete phrase probability of all matched |
| | tokens. |
| LOST_WORD_COMPLETENESS | Represents the maximum value of the |
| | complete phrase probability of all the |
| | unmatched tokens. |
| MATCHED_PHRASE_COMPLETENESS | Represents the value of the complete phrase |
| | probability for the longest expression in the |
| | matched tokens. Given an ordered list of |
| | matched words, the scoring application 224 |
| | is configured to search for the longest |
| | expression in the complete phrase probability |
| | map. Thus, if the normalized input job title is |
| | mapped to the candidate job title “Chief |
| | Execute Officer,” the scoring application 224 |
| | searches the complete phrase probability map |
| | for this exact 3-gram, and assigns the |
| | probability value found in the complete |
| | phrase probability map to this feature. |

Using the foregoing definition for the congruence type and information quality type features, an initial empirical study was conducted on a set of member profiles stored in the member profile database 120 and an initial title taxonomy 236 stored in the title taxonomy database 122. Table 3 provides a list of coefficient values for each of the features listed in Table 1 and Table 2 that were determined as a result of this empirical study.

TABLE 3

| Feature Name | Coefficient Value |
|---|---|
| HITS_NUM | 0.740355682 |
| FIRST_HIT_LOCATION | −0.230653968 |
| MAX_SKIP | −0.537254397 |
| MAX_NEGATIVE_SKIP | 0.167955508 |
| LOST_WORD_COMPLETENESS | −2.315106037 |
| MATCH_WORD_COMPLETENESS | 1.320795812 |
| LOST_WORD_LOG_COUNT | 0.450531556 |
| MATCHED_WORD_LOG_COUNT | 0.146050133 |
| MATCHED_PHRASE_COMPLETENESS | 0.233054289 |

Using the foregoing description of the title scoring application 224, title scoring model 238, and title scoring features 240, candidate title scores were determined given a normalized input job title and a candidate job title that the matching application 216 determined to be a match for the normalized input job title. Table 4 provides examples of these candidate title scores. The column of “Human Label” in Table 4 indicates whether a human indicated that the candidate job title accurately reflected the normalized input job title. In one embodiment, a crowdsourcing tool, such as that provided by CrowdFlower Inc., located in San Francisco, Calif., may be used to label the whether the candidate job title is a match for the normalized input job title. A value closer to one indicates that the candidate job title is a match for the normalized input job title and, by extension, the input job title provided by the member and/or the input job title associated with a corresponding member profile.

TABLE 4

| | | Human | |
|---|---|---|---|
| Normalized Input Job Title | Candidate Job Title | Label | Score |
| Senior Marketing Director | Senior Director of Marketing | 1 | 0.951499407 |
| Associate Investment Banking | Investment Banking Associate | 1 | 0.979754324 |
| Manager Sales & Marketing | Sales Marketing Manager | 1 | 0.756532725 |
| Correctional Officer Captain | Correctional Officer | 1 | 0.650034367 |
| Civil Engineering Professional | Civil Engineer | 1 | 0.531154679 |
| Live Nursery Specialist | Specialist | 0 | 0.355556337 |
| Detective Corporal | Corporal | 0 | 0.350315967 |
| Divisional Forest Officer | Officer | 0 | 0.35020935 |

In some instances, an input job title may be associated with multiple candidate job titles 234. Accordingly, the scoring application 224 is configured to score and rank the candidate job titles 234. The scoring application 224 may then select the highest ranking candidate job title as the standardized job title for the input job title. The title mapping application 226 is configured to establish an association between the input job title and the standardized job title selected by the scoring application 224. In one embodiment, establishing an association may include adding a value and/or field to the member profile corresponding to the input job title that references and/or includes the standardized job title. Additionally and/or alternatively, the social networking server 112 may provide a prompt or display to a member as he or she interacts with the social networking server that queries the member as to whether he or she would like to replace the input job title with the determined, standardized job title. In this regard, the title mapping application 226 may then replace the input job title of the corresponding member profile with the determined, standardized job title. Thus, the association between the input job title and the standardized job title may be implicit, explicit, or a combination thereof. By mapping the input job title to the standardized job title, the title mapping application 226 improves the data coherency of the job titles associated with the various member profiles of the member profile database 120 and improves the likelihood that relevant member profiles are found during a search for a given job title. In this manner, the foregoing determination of the candidate job titles and mapping of the input job title to a standardized job title has a technical effect on other technical fields, namely, database integrity, database management, and database searching.

FIG. 3 illustrates a workflow diagram 302 for determining a standardized job title for an input job title, according to an example embodiment. As shown in the workflow diagram 302, the normalizer 214 is configured to initially process one or more job titles used as input from member profiles stored in the member profile database 120. Additionally and/or alternatively, the job titles may be provided as input by a member as he or she is interacting with the social networking service.

After the normalizer 214 has processed one or more input job titles according to the normalization rules 230, the normalizer 214 may then instantiate and/or invoke the matching application 216 to match the normalized input job titles with standardized job titles stored in the title taxonomy 236. Depending on the results of the matching, the matching application 216 may then invoke the scoring application 224 (e.g., where at least one exact match was found) or may invoke other applications, such as the synonym identifier 218 and/or the n-gram tokenizer 222 (e.g., where an exact match was not found). The results of the synonym identifier may be communicated to the spelling correction application 220, which may then invoke the matching application 216 again. As with the results of the normalizer application 214, the matching application 216 may attempt to find matches for the results of the spelling correction application 214. Where matches are found, the matching application 216 may then invoke the scoring application 214 using the determined matches and their corresponding spell-corrected and normalized input job titles. Further still, where results are not found, the matching application 216 may further invoke the n-gram tokenizer 222 to tokenize the results of the spelling correction application 220. In turn, the n-gram tokenizer 222 may execute the matching application 216 on the n-grams obtained by the n-gram tokenizer 222, which may include one or more n-grams for a normalized input job title. The matching application 216 may then attempt to determine or more candidate job titles from the title taxonomy 236 that match the n-grams output by the n-gram tokenizer 222. The resulting set of matching titles determined by the matching application 216, if any, are then stored as the candidate job titles 234.

Although the foregoing description of the interactions between the normalizer 214, matching application 216, synonym identifier 218, spelling correction application 220, and the n-gram tokenizer 222 provides one example workflow for processing input job titles, one of ordinary skill in the art will appreciate that alternative workflows, including additional and/or fewer executions of the applications are also possible. For example, in some instances, the matching application 216 is instantiated after an input job title has been normalized, spell-corrected, and tokenized. In other instances, the matching application 216 is instantiated on a tokenized input job title, regardless of whether the input job title has been normalized and/or spell-corrected. Accordingly, in this manner, many different workflows are possible using the applications 208, and FIG. 3 illustrates just one example of the potential workflows.

The scoring application 224 then scores the candidate job titles 234 by comparing tokenized candidate job titles 234 with tokenized and normalized input job titles. In one embodiment, and as discussed earlier, the scoring application 224 determines the candidate title scores 242 using one or more title scoring features 240 and the title scoring model 238. The resulting output of the scoring application 224 is the initial set of candidate title scores 242, which the scoring application 224 then ranks to determine the candidate job title that most likely corresponds to and/or matches the normalized input job title provided to the matching application 216. The candidate job title with the highest candidate title score is then input to the title mapping application 226, which then creates an association between the input job title and the candidate job title. In this manner, the social networking server 112 determines a standardized job title for an input job title associated with a given member profile.

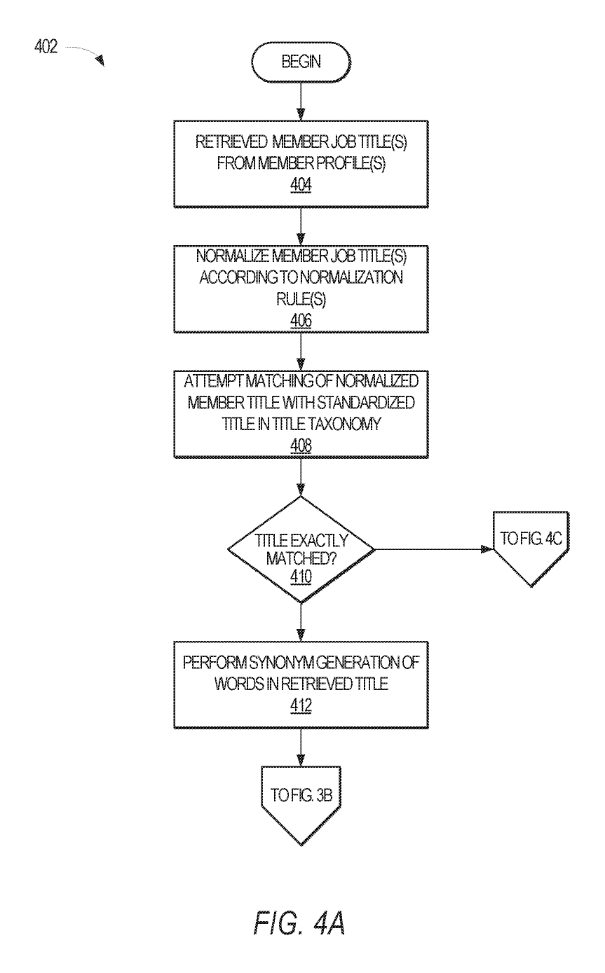

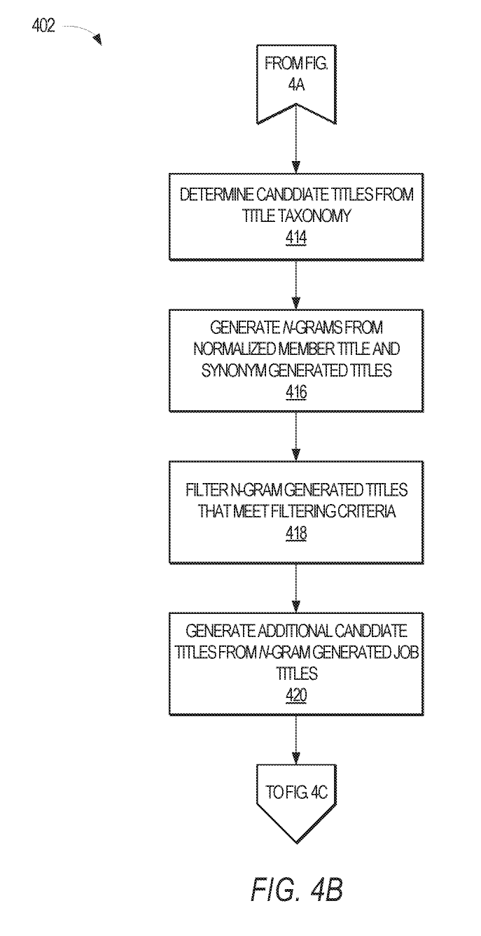

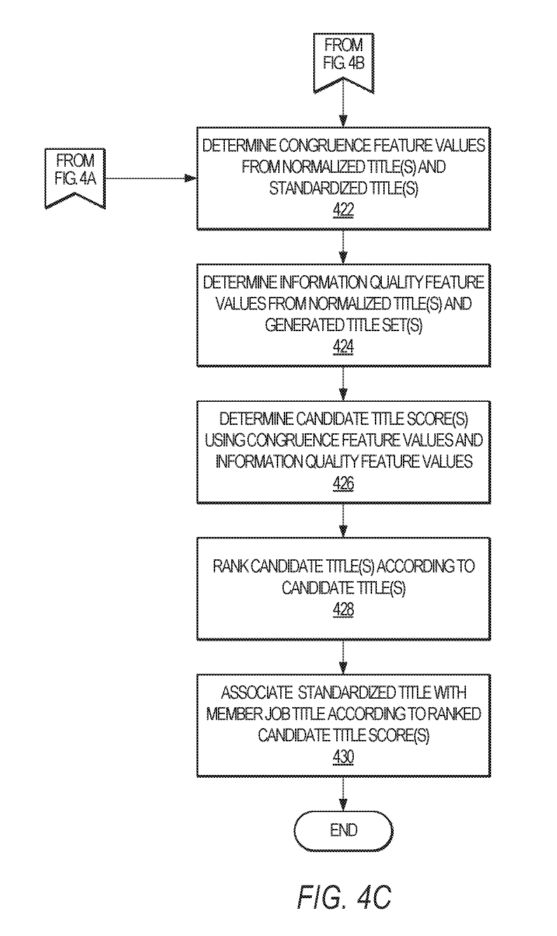

FIGS. 4A-4C are flow diagrams illustrating, in accordance with an example embodiment, a method 402 for determining a standardized job title for an input job title. The method 402 may be implemented by one or more of the applications 208 shown in FIG. 2, and is discussed by way of reference thereto.

Referring initially to FIG. 4A, the social networking server 112 initially retrieves one or more member job titles from one or member profiles stored in the member profile database 120 (Operation 404). In this regard, and as discussed previously, the social networking server 112 may execute the database access application 212 to retrieve the member job titles. The retrieved member job titles may then he stored as the input job title(s) 228. The normalizer 214 then normalizes one or more of the input job titles using the normalization rules 230 (Operation 406). The output of the normalizer is one or more normalized input job titles that correspond to the input job titles obtained from the member profiles and/or provided by a member of the social networking service. The normalizer 214 then communicates the one or more normalized input job titles to the matching application 216 to determine whether a standardized job title in the title taxonomy 236 matches the normalized input job title (Operation 408).

In one embodiment, and as explained previously, the matching application 216 attempts to determine whether there is an exactly matching standardized job title in the title taxonomy 236 (Operation 410). Where this determination is made in the affirmative (e.g., the “YES” branch of Operation 410), the method 402 proceeds to Operation 420 on FIG. 4C and as discussed further below. Where this determination is made in the negative (e.g., the “NO” branch of Operation 410), the method 402 proceeds to Operation 412.

At Operation 412, the synonym identifier 218 generates one or more synonyms for the normalized input job title, and invokes the spelling correction application 220 (Operation 412). In one embodiment, the synonym identifier 218 and/or the spelling correction application 220 generate a list of words and/or phrases that are synonyms for the normalized input job title.

Referring next to FIG. 4B, the matching application 216 attempts to determine one or more candidate job titles using the synonyms generated by the synonym identifier 218 and/or spelling correction application 220 (Operation 414). Thereafter, the matching application 216 and/or the spelling correction application 220 may invoke the n-gram tokenizer 222 to tokenize the synonym job titles and the normalized input job title into one or more n-grams (Operation 416). The n-gram tokenizer 222 may then filter out one or more n-grams having a predetermined word and/or phrase (Operation 418). For example, n-grams such as “of,” “to,” “the,” and “in” may be filtered out. In addition, n-grams that are portions of other n-grams may also be filtered out. For example, if the n-gram tokenizer 222 generates a hi-gram of “software engineer” and unigrams of “software” and “engineer,” the unigrams “software” and “engineer” may be filtered out as such unigrams are already captured by the “software engineer” bigram. In alternative embodiments, such unigrams are not filtered out. The matching application 216 may then determine one or more candidate job titles from the title taxonomy 236 that match the n-grams generated by the n-gram tokenizer 222 (Operation 420).

Thereafter, and referring to FIG. 4C, the candidate job titles and the normalized input job title are communicated to the scoring application 224, and the scoring application 224 determines the title scoring feature values 240 for the congruence type features (Operation 422). In one embodiment, the values of congruence type features for a given candidate job title is by comparing the given candidate job title with the normalized input job title determined at Operation 406. As discussed above, examples of the congruence type features are listed in Table 1. In another embodiment, the values of the congruence type features for a given candidate job title is by comparing the given candidate job title with the job title used to match the candidate job title (e.g., the n-gram or synonym input job title that resulted in the candidate job title). The scoring application 224 then determines the information quality feature values as discussed above with reference to Table 2 (Operation 424). Using the congruence type feature values, the information quality feature values (e.g., the title scoring feature values 240) and the title scoring model 238, the scoring application 224 then scores a given candidate job title, and stores the resulting candidate title score as part of the candidate title scores 242 (Operation 426). The scoring application 224 may then rank the candidate title scores 242 and communicate the candidate job title having the highest candidate title score to the title mapping application 226 (Operation 428). The title mapping application 226 may then associate the candidate job title as the standardized job title for its corresponding input job title (e.g., the member job title) (Operation 430).

In this manner, the disclosed systems and methods provide several technical benefits in the field of database management, including database data standardization, database data coherency, database searching, and comparative analysis. Even though members of a social networking service are given the freedom to provide input data that may vary widely, the disclosed systems and methods address this difficulty by providing a number of mechanisms that attempt to standardized the varying data and provide associations between the input data (e.g., the member job titles) and the standardized data (e.g., the standardized job titles). Furthermore, the disclosed systems and methods ensure that the standardized data most likely corresponds to the input data, thus reducing the likelihood that inconsistent associations are established and irrelevant comparisons are performed.

### Modules Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet)and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-5 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internee of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

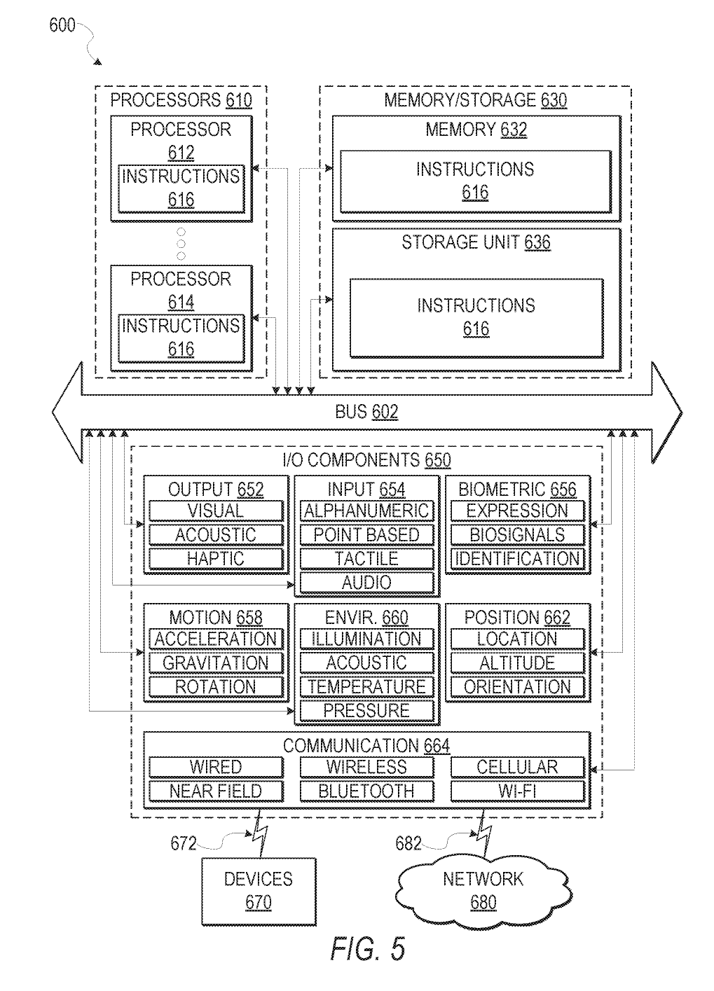

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example, the instructions 516 may cause the machine 500 to execute the algorithms associated with the flow diagrams of FIGS. 4A-4C. Additionally, or alternatively, the instructions 516 may implement one or more of the components of FIG. 2. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a PDA, or any machine capable of executing the instructions 516, sequentially or otherwise, that specify actions to be taken by machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory/storage 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 512 and processor 514 that may execute the instructions 516. The term “processor” is intended to include multi-core processor that may comprise two or more independent processors (sometimes referred to as “cores”) that may execute instructions 516 contemporaneously. Although FIG. 5 shows multiple processors 510 the machine 500 may include a single processor with a single core, a single processor with multiple cores (e.g., a multi-core process), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of processors 510 are examples of machine-readable media.

As used herein, “machine-readable medium” means a device able to store instructions 516 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562 among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a GPS receiver component), altitude sensor components altimeters or barometers that detect air pressure from which altitude may be derived), orientation sensor components (e.g., magnetometers and the like.

Communication may be implemented using a wide variety of technologies. The I/O components 550 may include communication components 564 operable to couple the machine 500 to a network 580 or devices 570 via coupling 582 and coupling 572, respectively. For example, the communication components 564 may include a network interface component or other suitable device to interface with the network 580. In further examples, communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (MD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF 416, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geo-location, location via Wi-Fi® signal triangulation, location via detecting a NFC beacon signal that may indicate a particular location, and so forth.

### Transmission Medium

in various example embodiments, one or more portions of the network 580 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or other type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LIE) standard, others defined by various standard setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., hypertext transfer protocol (HTTP)). Similarly, the instructions 516 may be transmitted or received using a transmission medium via the coupling 572 (e.g., a peer-to-peer coupling) to devices 570. The term “transmission medium” shall be taken to include any intangible medium that is capable of storing, encoding, or carrying instructions 516 for execution by the machine 500, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A system comprising:
a machine-readable medium storing computer-executable instructions; and
at least one hardware processor communicatively coupled to the machine-readable medium that, when the computer-executable instructions are executed, configures the system to:
obtain an input job title corresponding to a position within an organization possessed by a member of a social networking service;
normalize the input job title according to at least one normalization rule to obtain a normalized input job title;
determine a plurality of candidate job titles from a plurality of standardized job titles based on the normalized input job title;
determine a plurality of candidate job scores for the plurality of candidate job titles, where at least one candidate job score is based at least on a first feature that indicates congruency between a corresponding candidate job title and the normalized input job title and a second feature that indicates information quality between the corresponding candidate job title and the normalized input job title;
select the candidate job title having the highest candidate title job score; and
create an association between the selected candidate job title and the input job title.

2. The system of claim 1, wherein the at least one normalization rule defines a plurality of acceptable characters for the input job title, and the at least one hardware processor further configures the system to replace one or more characters of the input job title with at least one character selected from the plurality of acceptable characters.

3. The system of claim 1, wherein the second feature is based on the number of unmatched n-gram tokens between the normalized input job title and at least one candidate job title selected from the plurality of candidate job titles.

4. The system of claim 1, wherein the at least one hardware processor further configures the system to:
tokenize the normalized input job title into a plurality of n-grams; and
the plurality of candidate job titles are further determined based on the plurality of n-grams.

5. The system of claim 1, wherein the at least one candidate job score is further based on a document frequency of at least one n-gram token selected from a plurality of n-gram tokens that correspond to the normalized input job title.

6. The system of claim 1, wherein the at least one candidate job score is further based on a complete phrase probability of at least one n-gram token selected from a plurality of n-gram tokens corresponding to the normalized input job title.

7. The system of claim 1, wherein the at least one hardware processor further configures the system to display a prompt that queries whether the input job title is to be replaced with the candidate job title.

8. A method comprising:
obtaining an input job title from a member profile stored in a member profile database, the input job title corresponding to a position within an organization possessed by a member of a social networking service;
normalizing the input job title according to at least one normalization rule to obtain a normalized input job title;
determining a plurality of candidate job titles from a plurality of standardized job titles based on the normalized input job title;
determining a plurality of candidate job scores for the plurality of candidate job titles, where at least one candidate job score is based at least on a first feature that indicates congruency between a corresponding candidate job title and the normalized input job title and a second feature that indicates information quality between the corresponding candidate job title and the normalized input job title;
selecting the candidate job title having the highest candidate title job score; and
creating an association between the selected candidate job title and the input job title in the member profile.

9. The method of claim 8, wherein the at least one normalization rule defines a plurality of acceptable characters for the input job title, and the method further comprises replacing one or more characters of the input job title with at least one character selected from the plurality of acceptable characters.

10. The method of claim 8, wherein the second feature is based on the number of unmatched n-gram tokens between the normalized input job title and at least one candidate job title selected from the plurality of candidate job titles.

11. The method of claim 8, further comprising;
tokenizing the normalized input job title into a plurality of n-grams; and
determining the plurality of candidate job titles based on the plurality of n-grams.

12. The method of claim 8, wherein the at least one candidate job score is further based on a document frequency of at least one n-gram token selected from a plurality of n-gram tokens that correspond to the normalized input job title.

13. The method of claim 8, wherein the at least one candidate job score is further based on a complete phrase probability of at least one n-gram token selected from a plurality of n-gram tokens corresponding to the normalized input job title.

14. The method of claim 8, further comprising displaying a prompt that queries whether the input job title is to be replaced with the candidate job title.

15. A non-transitory, machine-readable medium having computer-executable instructions stored thereon that, when executed by one or more hardware processors, cause the one or more hardware processors to perform a plurality of operations comprising:
obtaining an input job title from a member profile stored in a member profile database, the input job title corresponding to a position within an organization possessed by a member of a social networking service;
normalizing the input job title according to at least one normalization rule to obtain a normalized input job title;
determining a plurality of candidate job titles from a plurality of standardized job titles based on the normalized input job title;
determining a plurality of candidate job scores for the plurality of candidate job titles, where at least one candidate job score is based at least on a first feature that indicates congruency between a corresponding candidate job title and the normalized input job title and a second feature that indicates information quality between the corresponding candidate job title and the normalized input job title;
selecting the candidate job title having the highest candidate title job score; and
creating an association between the selected candidate job title and the input job title in the member profile.

16. The non-transitory, machine-readable medium of claim 15, wherein the at least one normalization rule defines a plurality of acceptable characters for the input job title, and the plurality of operations further comprise replacing one or more characters of the input job title with at least one character selected from the plurality of acceptable characters.

17. The non-transitory, machine-readable medium of claim 15, wherein the second feature is based on the number of unmatched n-gram tokens between the normalized input job title and at least one candidate job title selected from the plurality of candidate job titles.

18. The non-transitory, machine-readable medium of claim 15, wherein the plurality of operations further comprise:
tokenizing the normalized input job title into a plurality of n-grams; and
determining the plurality of candidate job titles based on the plurality of n-grams.

19. The non-transitory, machine-readable medium of claim 15, wherein the at least one candidate job score is further based on a document frequency of at least one n-gram token selected from a plurality of n-gram tokens that correspond to the normalized input job title,

20. The non-transitory, machine-readable medium of claim 15, wherein the at least one candidate job score is further based on a complete phrase probability of at least one n-gram token selected from a plurality of n-gram tokens corresponding to the normalized input job title.
